(19) United States
(12) Patent Application Publication
(10) Pub. No.: US 2022/0059848 A1
(43) Pub. Date: Feb. 24, 2022

(54) FUEL CELL CATHODE SUBSTRATE INCLUDING HOLLOW FIBERS

(71) Applicant: DOOSAN FUEL CELL AMERICA, INC., South Windsor, CT (US)

(72) Inventors: Timothy William Patterson, JR., West Hartford, CT (US); Jeff Dugan, Erwin, TN (US); Cameron Miller, Piney Flats, TN (US); Paul L. Latten, Huntersville, NC (US); Matthew A. Johnson, Wilmington, NC (US)

(21) Appl. No.: 16/995,947

(22) Filed: Aug. 18, 2020

(51) Int. Cl. H01M 4/86; H01M 4/88

(52) U.S. Cl. CPC H01M 4/8626; H01M 2004/8689; H01M 4/8803

(57) ABSTRACT

An illustrative example porous fuel cell component includes a plurality of fibers, a plurality of first pores defined by spaces between the fibers, and a plurality of second pores defined by an interior space in at least some of the fibers. Another illustrative example porous fuel cell component includes a plurality of first fibers and a plurality of second fibers that are different than the first fibers. The second fibers are hollow.

### BACKGROUND

Fuel cells generate electricity based on an electrochemical reaction between reactants such as hydrogen and oxygen. Fuel cell devices include a number of fuel cells in a cell stack assembly. One issue associated with liquid electrolyte fuel cells is managing the electrolyte within the cell stack assembly. Maintaining adequate electrolyte throughout the stack and preventing flooding are important to keeping the cell stack assembly operational.

During fuel cell operation, the electrolyte tends to collect in the anode substrate with very little remaining in the cathode substrate. A challenge associated with attempting to increase the electrolyte content in the cathode substrate during operation is that when the fuel cell is not generating electrical current the cathode substrate could become flooded, which leads to difficulty starting the fuel cell.

### SUMMARY

An illustrative example porous fuel cell component includes a plurality of fibers, a plurality of first pores defined by spaces between the fibers, and a plurality of second pores defined by an interior space in at least some of the fibers.

In an example embodiment having at least one feature of the porous fuel cell component of the previous paragraph, the plurality of fibers includes first fibers and second fibers that are different than the first fibers, the second fibers are hollow, and the second pores are defined by the interior of the second fibers.

In an example embodiment having at least one feature of the porous fuel cell component of any of the previous paragraphs, the first pores have a first size within a first range and the second pores have a second size within a second range that is lower than the first range.

In an example embodiment having at least one feature of the porous fuel cell component of any of the previous paragraphs, the first range is from 20 micrometers to 40 micrometers and the second range is from 2 micrometers to 20 micrometers.

In an example embodiment having at least one feature of the porous fuel cell component of any of the previous paragraphs, a majority of the first pores have a first pore size that is larger than a second pore size of a majority of the second pores.

In an example embodiment having at least one feature of the porous fuel cell component of any of the previous paragraphs, 30% to 80% of a porosity of the component comprises the first pores and about 20% to 70% of the porosity comprises the second pores.

Another illustrative example porous fuel cell component includes a plurality of first fibers and a plurality of second fibers that are different than the first fibers. The second fibers are hollow.

In an example embodiment having at least one feature of the porous fuel cell component of the previous paragraph, the first fibers comprise a first material and the second fibers comprise a second, different material.

In an example embodiment having at least one feature of the porous fuel cell component of any of the previous paragraphs, the second fibers comprise polyphenylene sulfide.

In an example embodiment having at least one feature of the porous fuel cell component of any of the previous paragraphs, the second fibers comprise polyphenyl sulfone.

In an example embodiment having at least one feature of the porous fuel cell component of any of the previous paragraphs, the component includes a plurality of first pores defined by spaces between the fibers and a plurality of second pores defined by an interior of the second fibers.

In an example embodiment having at least one feature of the porous fuel cell component of any of the previous paragraphs, the first pores have a first size within a first range and the second pores have a second size within a second range that is lower than the first range.

In an example embodiment having at least one feature of the porous fuel cell component of any of the previous paragraphs, the first range is from 20 micrometers to 40 micrometers and the second range is from 2 micrometers to 20 micrometers.

In an example embodiment having at least one feature of the porous fuel cell component of any of the previous paragraphs, a majority of the first pores have a first pore size that is larger than a second pore size of a majority of the second pores.

In an example embodiment having at least one feature of the porous fuel cell component of any of the previous paragraphs, 30% to 80% of a porosity of the component comprises the first pores and about 20% to 70% of the porosity comprises the second pores.

Various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a fuel cell assembly.

FIG. 2 schematically illustrates selected features of a porous fuel cell component.

FIG. 3 schematically illustrates an arrangement of fibers including a pore between fibers and a pore within a hollow fiber.

### DETAILED DESCRIPTION

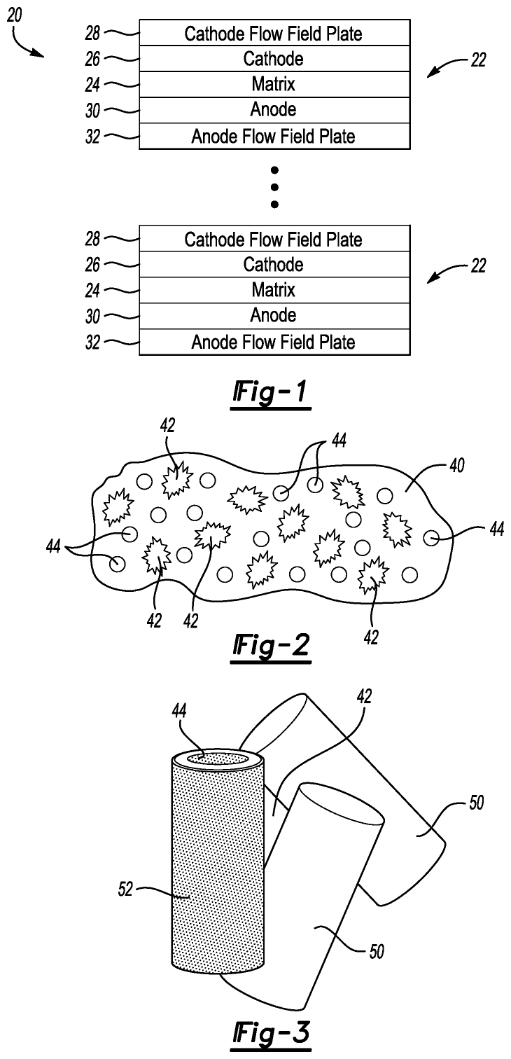

FIG. 1 schematically illustrates a fuel cell assembly 20. A plurality of fuel cells 22 are arranged in a stack. Each of the fuel cells 22 includes a matrix 24 that contains a liquid electrolyte, such as phosphoric acid. A cathode 26 is situated on one side of the matrix 24. A cathode flow field plate 28 is configured to supply oxygen to the cathode 26. An anode 30 is situated on an opposite side of the matrix 24. An anode flow field plate 32 is configured to supply hydrogen to the anode 30. The fuel cells 22 generate electricity based on an electrochemical reaction in a known manner.

Each cathode 26 comprises a substrate that is porous and made of fibers. There are two different types of pores and at least two different types of fibers in the example cathodes 26. The different types of pores facilitate maintaining liquid electrolyte in the cathode 26 during fuel cell operation and minimize or avoid the cathode 26 becoming flooded when the fuel cell 22 is idle.

FIG. 2 schematically illustrates a portion of the material 40 of the cathodes 26. The material 40 is porous and includes first pores 42 that are defined or established by spaces between fibers of the material 40. Second pores 44 are defined by an inside of at least some of the fibers of the material 40.

The example first pores 42 are larger than the second pores 44. The first pores 42 in some embodiments have a size in a range from 20 micrometers to 40 micrometers. The second pores in such embodiments have a size in a range from 2 micrometers to 20 micrometers. At least a majority of the first pores 42 are greater than a majority of the second pores 44. For example, 80% of the first pores 42 have a size larger than 20 micrometers and 80% of the second pores 44 have a size less than 20 micrometers. In some embodiments, an average size of the first pores 42 may be at least about twice as large as the average size of the second pores 44. In some embodiments the average size of the first pores 42 is 30 micrometers and the average size of the second pores 44 is 10 micrometers.

Even though the first pores 42 are larger than the second pores 44, the first pores 42 do not necessarily establish more of the porosity of the cathode 26 than the second pores 44. For example, the first pores 42 establish between 30% and 80% of the pore space of the cathode 26 and the second pores 44 establish between 20% and 70% of the overall pore space.

FIG. 3 schematically illustrates example fibers of the material 40 of the cathode 26. First fibers 50 and second fibers 52 are arranged to establish the substrate of the cathode 26. An example first pore 42 is shown as a space between the fibers. An example second pore 44 is shown as the interior of the illustrated second fiber 52.

The first fibers 50 are different than the second fibers 52. One way in which the first fibers 50 and the second fibers 52 are different is that the second fibers 52 are hollow. As schematically shown in FIG. 3, an open interior of the second fibers 52 establishes or defines the second pores 44. The hollow interior of the second fibers 52 may extend completely through each second fiber 52 or may be a blind hole in the fiber. In some embodiments the second fibers are tubular in form and are hollow along their entire length.

The material composition of the fibers is also different in this example embodiment. The first fibers 50 are carbon fibers. The second fibers 52 comprise a different material. The second fibers 52 in some embodiments comprise polymer fibers that are carbonized leaving carbon as at least a residue or coating on the second fibers 52. In some embodiments, the polymer material of the second fibers 52 is entirely carbonized leaving carbon second fibers 52.

One example embodiment includes second fibers 52 comprising polyphenylene sulfide (PPS) or polyphenyl sulfone (PPSU). The second fibers 52 in that embodiment include polypropylene inside a tube of PPS. During a process of making the cathode 26, the second fibers 52 are heated and the polypropylene is essentially consumed leaving very little residue behind, which results in each of the second fibers 52 having a hollow core interior. The PPSU char content in an example embodiment is at least 40%, leaving a porous shell around the hollow core. The hollow core interior is configured to retain liquid electrolyte inside the second fibers 52 during at least some fuel cell operation conditions.

As schematically shown in FIG. 3, the second fibers 52 of this embodiment are porous to allow liquid electrolyte to pass through the body of the second fibers 52 as needed.

Including two types of pores in the cathode 26 addresses the need to retain liquid electrolyte in a fuel cell cathode during slump that occurs during fuel cell operation. Without the bimodal pore content of the cathode 26, the liquid electrolyte tends to be transferred into the anode 30 during operation but the unique pore size distribution of the cathode 26 (i.e., including the first pores 42 and the second pores 44) reduces or minimizes that transfer. The bimodal pore size distribution also prevents flooding of the cathode 26 when the fuel cell 22 is not generating electricity because the first pores 42 are large enough to provide a porosity that reduces or eliminates flooding the cathode 26. The smaller second pores 44 serve to retain liquid electrolyte in the cathode 26 and the larger first pores 42 prevent flooding.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A porous fuel cell component comprising a plurality of fibers, a plurality of first pores defined by spaces between the fibers, and a plurality of second pores defined by an interior space in at least some of the fibers.

2. The porous fuel cell component of claim 1, wherein
the plurality of fibers includes first fibers and second fibers that are different than the first fibers,
the second fibers are hollow, and
the second pores are defined by the interior of the second fibers.

3. The porous fuel cell component of claim 1, wherein
the first pores have a first size within a first range and
the second pores have a second size within a second range that is lower than the first range.

4. The porous fuel cell component of claim 3, wherein
the first range is from 20 micrometers to 40 micrometers and
the second range is from 2 micrometers to 20 micrometers.

5. The porous fuel cell component of claim 1, wherein a majority of the first pores have a first pore size that is larger than a second pore size of a majority of the second pores.

6. The porous fuel cell component of claim 1, wherein 30% to 80% of a porosity of the component comprises the first pores and about 20% to 70% of the porosity comprises the second pores.

7. A porous fuel cell component comprising a plurality of first fibers and a plurality of second fibers that are different than the first fibers, wherein the second fibers are hollow.

8. The porous fuel cell component of claim 7, wherein the first fibers comprise a first material and the second fibers comprise a second, different material.

9. The porous fuel cell component of claim 8, wherein the second fibers comprise polyphenylene sulfide.

10. The porous fuel cell component of claim 8, wherein the second fibers comprise polyphenyl sulfone.

11. The porous fuel cell component of claim 7, wherein the component includes a plurality of first pores defined by spaces between the fibers and a plurality of second pores defined by an interior of the second fibers.

12. The porous fuel cell component of claim 11, wherein
the first pores have a first size within a first range and
the second pores have a second size within a second range that is lower than the first range.

13. The porous fuel cell component of claim 12, wherein
the first range is from 20 micrometers to 40 micrometers and
the second range is from 2 micrometers to 20 micrometers.

14. The porous fuel cell component of claim 11, wherein a majority of the first pores have a first pore size that is larger than a second pore size of a majority of the second pores.

15. The porous fuel cell component of claim 11, wherein 30% to 80% of a porosity of the component comprises the first pores and about 20% to 70% of the porosity comprises the second pores.
